(19) United States
(12) Patent Application Publication
(10) Pub. No.: US 2007/0064642 A1
(43) Pub. Date: Mar. 22, 2007

(54) CELL SEARCH OF TIME-OVERLAPPING CELLS IN A MOBILE COMMUNICATION SYSTEM

(76) Inventors: Hiroaki Watabe, Tokyo (JP); Torgny Palenius, Barseback (SE)

Correspondence Address: POTOMAC PATENT GROUP, PLLC, P. O. BOX 270, FREDERICKSBURG, VA, 22404, US

(21) Appl. No.: 11/277,141

(22) Filed: Mar. 21, 2006

Related U.S. Application Data
(60) Provisional application No. 60/718,733, filed on Sep. 21, 2005.

(51) Int. Cl. H04B 7/212

(52) U.S. Cl. 370/324; 455/502; 455/525; 370/320

(57) ABSTRACT

A cell search in a spread spectrum telecommunication system is performed by determining a spreading code of an undetected neighbor cell; and de-spreading a received signal using the scrambling code of the undetected neighbor cell at a path delay position of an already-detected cell. The undetected neighbor cell may be identified by means of a neighbor list received from a network of the spread spectrum telecommunication system. A path searcher can be used to perform de-spreading the received signal using the scrambling code of the undetected neighbor cell at the path delay position of an already-detected cell. Concurrently with this operation, a cell searcher can be used to perform a path-masked cell search procedure.

### CROSS REFERENCE TO RELATED APPLICATIONS

This application claims the benefit of U.S. Provisional Application No. 60/718,733, filed Sep. 21, 2005, which is hereby incorporated herein by reference in its entirety.

### BACKGROUND

This invention relates to communication systems and more particularly to cell searching in a mobile telecommunication system.

Digital communication systems include time-division multiple access (TDMA) systems, such as cellular radio telephone systems that comply with the GSM telecommunication standard and its enhancements like GSM/EDGE, and code-division multiple access (CDMA) systems, such as cellular radio telephone systems that comply with the IS-95, cdma2000, and wideband CDMA (WCDMA) telecommunication standards. Digital communication systems also include “blended” TDMA and CDMA systems, such as cellular radio telephone systems that comply with the universal mobile telecommunications system (UMTS) standard, which specifies a third generation (3G) mobile system being developed by the European Telecommunications Standards Institute (ETSI) within the International Telecommunication Union's (ITU's) IMT-2000 framework. The Third Generation Partnership Project (3GPP) promulgates the UMTS standard. This application focuses on WCDMA systems for economy of explanation, but it will be understood that the principles described in this application can be implemented in other digital communication systems.

WCDMA is based on direct-sequence spread-spectrum techniques, with pseudo-noise scrambling codes and orthogonal channelization codes separating base stations and physical channels (user equipment or users), respectively, in the downlink (base-to-user equipment) direction. User Equipment (UE) communicates with the system through, for example, respective dedicated physical channels (DPCHs). WCDMA terminology is used here, but it will be appreciated that other systems have corresponding terminology. Scrambling and channelization codes and transmit power control are well known in the art.

FIG. 1 depicts a mobile radio cellular telecommunication system 100, which may be, for example, a CDMA or a WCDMA communication system. Radio network controllers (RNCs) 112, 114 control various radio network functions including for example radio access bearer setup, diversity handover, and the like. More generally, each RNC directs UE calls via the appropriate base station(s) (BSs), which communicate with each other through downlink (i.e., base-to-UE or forward) and uplink (i.e., UE-to-base or reverse) channels. RNC 112 is shown coupled to BSs 116, 118, 120, and RNC 114 is shown coupled to BSs 122, 124, 126. Each BS serves a geographical area that can be divided into one or more cell(s). BS 126 is shown as having five antenna sectors S1-S5, which can be said to make up the cell of the BS 126. The BSs are coupled to their corresponding RNCs by dedicated telephone lines, optical fiber links, microwave links, and the like. Both RNCs 112, 114 are connected with external networks such as the public switched telephone network (PSTN), the Internet, and the like through one or more core network nodes like a mobile switching center (not shown) and/or a packet radio service node (not shown). In FIG. 1, UEs 128, 130 are shown communicating with plural base stations: UE 128 communicates with BSs 116, 118, 120, and UE 130 communicates with BSs 120, 122. A control link between RNCs 112, 114 permits diversity communications to/from UE 130 via BSs 120, 122.

At the UE, the modulated carrier signal (Layer 1) is processed to produce an estimate of the original information data stream intended for the receiver. The composite received baseband spread signal is commonly provided to a RAKE processor that includes a number of “fingers”, or de-spreaders, that are each assigned to respective ones of selected components, such as multipath echoes or streams from different base stations, in the received signal. Each finger combines a received component with the scrambling sequence and the appropriate channelization code so as to de-spread a component of the received composite signal. The RAKE processor typically de-spreads both sent information data and pilot or training symbols that are included in the composite signal.

FIG. 2 is a block diagram of a receiver 200, such as a UE in a WCDMA communication system, that receives radio signals through an antenna 201 and down-converts and samples the received signals in a front-end receiver (Fe RX) 203. The output samples are fed from Fe RX 203 to a RAKE combiner and channel estimator 205 that de-spreads the received data including the pilot channel, estimates the impulse response of the radio channel, and de-spreads and combines received echoes of the received data and control symbols. In order to de-spread the received signal, the RAKE combiner and channel estimator 205 needs to know which, of the possible paths that the received signal might be spread on, are the strongest ones. In order to identify these strongest paths (experienced by the receiver 200 as delayed receipt of the signal), the RAKE combiner and channel estimator 205 includes a path searcher 207. An output of the combiner/estimator 205 is provided to a symbol detector 209 that produces information that is further processed as appropriate for the particular communication system. RAKE combining and channel estimation are well known in the art. It is also beneficial for the receiver 200 to have information about what other cells are in its environment, and for this purpose also includes a cell searcher 211 coupled to receive signals from the FeRX 203, and to provide results of its cell search operation to the RAKE combiner and channel estimator 205. The cell searcher 211 is described in more detail below.

A fundamental aspect of communication is the ability of a receiver 200 to identify synchronization points of a received signal, that is, to determine where in a received signal the starting point of transmitted data is located. In WCDMA systems, a Synchronization Channel (SCH) is used for this purpose. FIG. 3 is a timing diagram of an exemplary structure of an SCH 300. As shown in FIG. 3, SCH 300 itself comprises a Primary Synchronization Channel (P-SCH) and a Secondary Synchronization Channel (S-SCH). Frames, each lasting 10 ms, are made up of 15 slots, each slot lasting 2560 chips. Bursts having a length of 256 chips are transmitted on each of the P-SCH and S-SCH. The P-SCH burst (“acₚ”, where “cp” denotes the Primary Synchronization Code, and “a” takes on a value of ±1 to indicate the presence/absence of STTD encoding on the P-CCPCH) is identical in all slots and in all cells. The S-SCH burst (acₛ^{j,k}, where “cₛ” denotes the Secondary Synchronization Code, “a” takes on a value of ±1 to indicate the presence/absence of STTD encoding on the P-CCPCH, “j” is a sequence number and “k” is the slot number) varies slot by slot based on 16 varieties of Secondary Synchronization Code (SSC) sequences (thus j∈{0 . . . 15}), and one frame structured by 15 SSCs can be read as a 15-symbol code word, each of which corresponds to one code group out of 64.

Even if a UE is already in communication with a base station, it is important (e.g., for handoff determination) for the UE to detect what other cells are in its vicinity. An exemplary embodiment of a cell search procedure is shown in the flowchart of FIG. 4. First, because the P-SCH burst (acₚ) is identical in all slots and in all cells, slot synchronization is acquired by processing a received signal with the matched filter for P-SCH or any similar device (step 401). More particularly, a known primary synchronization code is correlated against the received signal for a range of delay values that span the duration of a slot (e.g., in WCDMA, over at least 2560 chips). This generates a correlation value for each tested delay.

As mentioned, above, the primary synchronization code (acₚ) appears once in each time slot contained in a transmitted frame. (In WCDMA, each frame includes 15 time slots). In order to improve performance (e.g., to mitigate the effects of a short fade in the signal), this correlation process is repeated for each of a number of successively received time slots. That is, if the duration of a time slot is Tₛ, then for each delay value T_{d}, a correlation is performed at a position T_{corr}(n)=T_{d}+nTₛ, where n=0, . . . , Nₜₑₛₜ_{_{—}}ₛₗₒₜₛ−1 and Nₜₑₛₜ_{_{—}}ₛₗₒₜₛ is the number of slots to be tested. For example, in the exemplary WCDMA system, one might perform the at least 2560 test correlations for each of the 15 slots known to be present in a frame.

For each tested delay value, the resultant correlation values are then accumulated. The maximum accumulated value is then taken as the slot boundary for a cell.

Knowledge of the slot boundary does not, by itself, inform the device of what the frame boundary is, because as mentioned earlier, each frame includes more than one slot. Thus, once slot synchronization is acquired, the S-SCH is used to detect the frame synchronization and scrambling code group (step 403). This is achieved by correlating the received signal starting from the obtained slot timing, with all possible S-SCH code sequences. When the corresponding S-SCH code sequence is lined up with the start of the frame, the highest correlation is achieved, thereby identifying both the start of the frame as well as which scrambling code group is used.

Finally, the received signal is correlated with all codes within the just-identified code group (step 405), in order to identify exactly which code was used. In accordance with communication system standards such as those set forth for WCDMA, each secondary synchronization code is, itself, associated with a particular set of scrambling codes. The scrambling code is located once in each frame at a known offset from the frame boundary. Thus, in this phase of the cell search process, the scrambling code for the cell is found by correlating each of the scrambling codes associated with the known secondary synchronization code against the received signal at the known offset from the frame boundary. The highest correlating scrambling code is then taken to be the scrambling code for this “searched” cell.

Taking a closer look at step 401 in which slot synchronization is initially acquired, the cell searcher 211 correlates a known synchronization code against the received signal at all chip offset positions within a slot, and correlated metrics are accumulated over slots at each chip offset position. Then, a delay position with the maximum accumulated value is taken as a candidate of a slot boundary position from a new cell. In this process, there is no guarantee that the cell searcher 211 will not find the slot timing of an already detected cell. To avoid this, the cell searcher 211 does not perform accumulation of correlated metrics at path delay positions of already detected cells. This procedure is called “path masking,” and the set of delay positions to be masked out at the first step of the cell searcher 211 is called the “path mask.”

US 2004/0259576, entitled “Filtering Multipath Propagation Delay Values for Use in a Mobile Communications System” describes just such a path masking procedure.

Path masking can introduce problems in multiple cell environments because there are circumstances in which the UE receives SCH bursts at the same timing from different cells. These circumstances can be categorized as follows:

Case (A): Overlapping P-SCHs

This is a case in which the UE receives two P-SCH's, coming from two different base stations, at the same slot timing at a certain location. This can occur at certain locations within a macro cell environment. Because one chip corresponds to approximately 80 meters, the area in which the UE can experience two P-SCHs overlapping will not be very large.

Case (B): Overlapping of both P-SCH and S-SCH

This case happens when several cells using a same scrambling code group are located at the same position with the frame timing aligned, so that the UE receives both P-SCH and S-SCH at the same frame timing. This can occur frequently whenever the cell planning is done so intentionally, such as in micro and pico cell environments with several cells sharing the same frequency generators, and macro cells within the same base station. With such cell network design, the received power from the SCH increases in the area where the UE can receive signals from more than one cell. Then, the coverage may be improved in such an area.

As described above, however, the cell searcher 211 will never search in certain chip positions defined by the path mask, and will always therefore end up without finding new detectable cells in such environments. Therefore, it is highly possible that the UE will lose synchronization to a network as it moves.

To mitigate the case (A) condition, one can optimize a path mask generation algorithm to reduce the number of masked-out delay positions and to reduce the amount of time that is considered to be overlapping with known cells. However, such optimization increases complexity of path mask management.

To solve the case (B) problem, one can turn off the path mask from time to time in order to perform a cell search procedure at path delay positions of already detected cells. However, the cell searcher 211 resource is usually occupied for normal searching with path masking enabled. Time sharing this resource between cell searching with the path mask enabled and cell searching with the path mask disabled (for time-overlapping cell search) would become difficult and complicated without sacrificing total cell search performance.

It is therefore desired to provide methods and apparatuses that address the time-overlapped cell search and/or other related problems.

### SUMMARY

It should be emphasized that the terms “comprises” and “comprising”, when used in this specification, are taken to specify the presence of stated features, integers, steps or components; but the use of these terms does not preclude the presence or addition of one or more other features, integers, steps, components or groups thereof.

In accordance with one aspect of the present invention, the foregoing and other objects are achieved in methods and apparatuses that perform a cell search in a spread spectrum telecommunication system. In one aspect, this involves determining a spreading code of an undetected neighbor cell; and de-spreading a received signal using the scrambling code of the undetected neighbor cell at a path delay position of an already-detected cell.

In another aspect, the cell search involves receiving a neighbor list from a network of the spread spectrum telecommunication system; and using the neighbor list to identify the undetected neighbor cell.

In yet another aspect, a path-masked cell search procedure may be concurrently performed. In some embodiments, a cell searcher is used to perform the path-masked cell search procedure, and a path searcher is used to perform de-spreading the received signal using the scrambling code of the undetected neighbor cell at the path delay position of an already-detected cell.

In still another aspect, de-spreading the received signal using the scrambling code of the undetected neighbor cell at the path delay position of the already-detected cell comprises de-spreading the received signal using the scrambling code of the undetected neighbor cell at path delay positions of all already-detected cells.

In yet another aspect, the path delay position of the already-detected cell is an offset from a known slot timing of the already-detected cell.

In still another aspect, the path delay position of the already-detected cell is an offset from a known frame timing of the already-detected cell.

In yet another aspect, de-spreading the received signal using the scrambling code of the undetected neighbor cell at the path delay position of the already-detected cell comprises generating a plurality of correlation results by de-spreading the received signal using the scrambling code of the undetected neighbor cell at path delay positions of the already-detected cell at each of a plurality of slots; and accumulating the correlation results.

### BRIEF DESCRIPTION OF THE DRAWINGS

The objects and advantages of the invention will be understood by reading the following detailed description in conjunction with the drawings in which:

FIG. 1 depicts an exemplary mobile radio cellular telecommunication system, which may be, for example, a CDMA or a WCDMA communication system.

FIG. 2 is a block diagram of a receiver in an exemplary WCDMA communication system.

FIG. 3 is a timing diagram of an exemplary structure of an SCH.

FIG. 4 is a flowchart of an exemplary embodiment of a cell search procedure.

FIGS. 5A and 5B together constitute a flowchart of processes/steps that are performed in accordance with an exemplary embodiment of the invention.

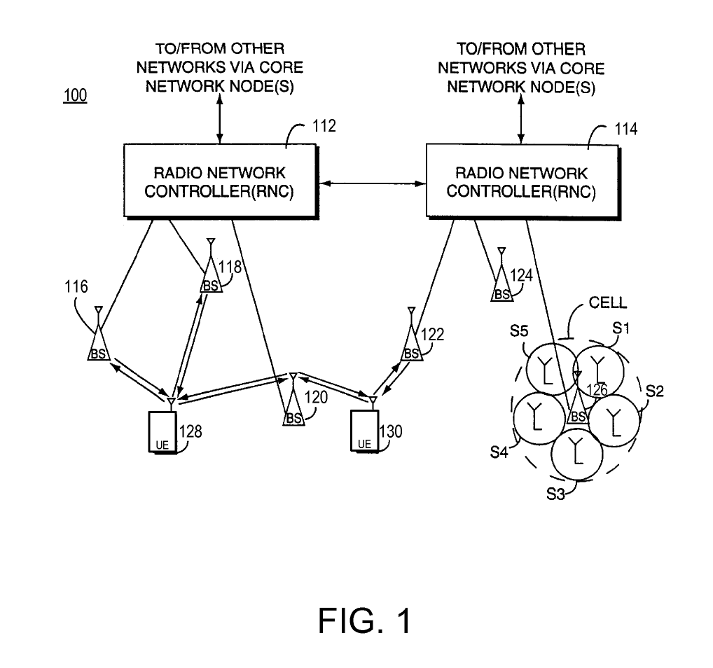

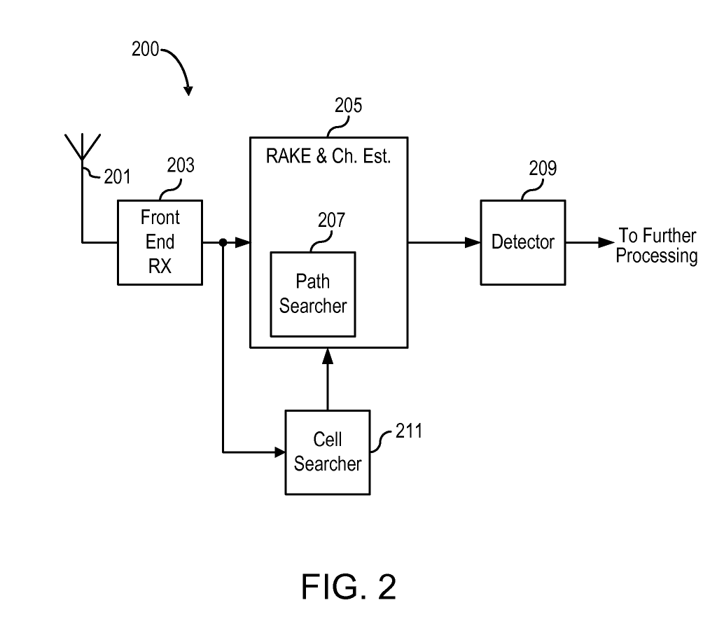

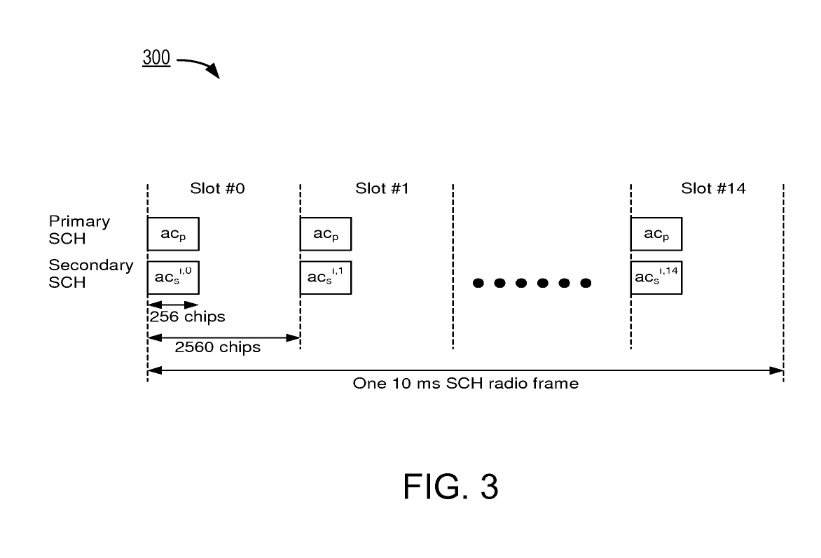

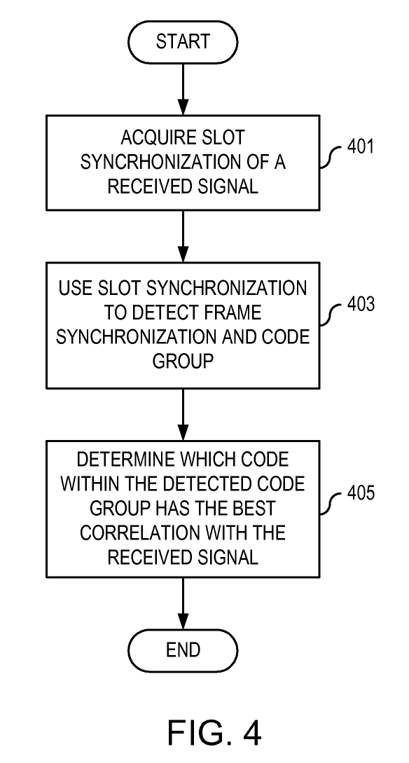

### DETAILED DESCRIPTION

The various features of the invention will now be described with reference to the figures, in which like parts are identified with the same reference characters.

The various aspects of the invention will now be described in greater detail in connection with a number of exemplary embodiments. To facilitate an understanding of the invention, many aspects of the invention are described in terms of sequences of actions to be performed by elements of a computer system or other hardware capable of executing programmed instructions. It will be recognized that in each of the embodiments, the various actions could be performed by specialized circuits (e.g., discrete logic gates interconnected to perform a specialized function), by program instructions being executed by one or more processors, or by a combination of both. Moreover, the invention can additionally be considered to be embodied entirely within any form of computer readable carrier, such as solid-state memory, magnetic disk, optical disk or carrier wave (such as radio frequency, audio frequency or optical frequency carrier waves) containing an appropriate set of computer instructions that would cause a processor to carry out the techniques described herein. Thus, the various aspects of the invention may be embodied in many different forms, and all such forms are contemplated to be within the scope of the invention. For each of the various aspects of the invention, any such form of embodiments may be referred to herein as “logic configured to” perform a described action, or alternatively as “logic that” performs a described action.

In one aspect of embodiments in conformance with the invention, methods and apparatuses are provided for identifying one or more cells whose timing overlaps with one or more known cells. This is achieved by de-spreading the received signal with scrambling codes of undetected neighbor cells at path delay positions of all identified cells. In another aspect, this is performed by the path searcher 207 rather than in the cell searcher 211, so that the search for overlapping cells can be performed in parallel with the normal cell search procedure being performed by the cell searcher 211. The path searcher 207 runs infrequently, which simplifies time-sharing of the path searcher hardware resource.

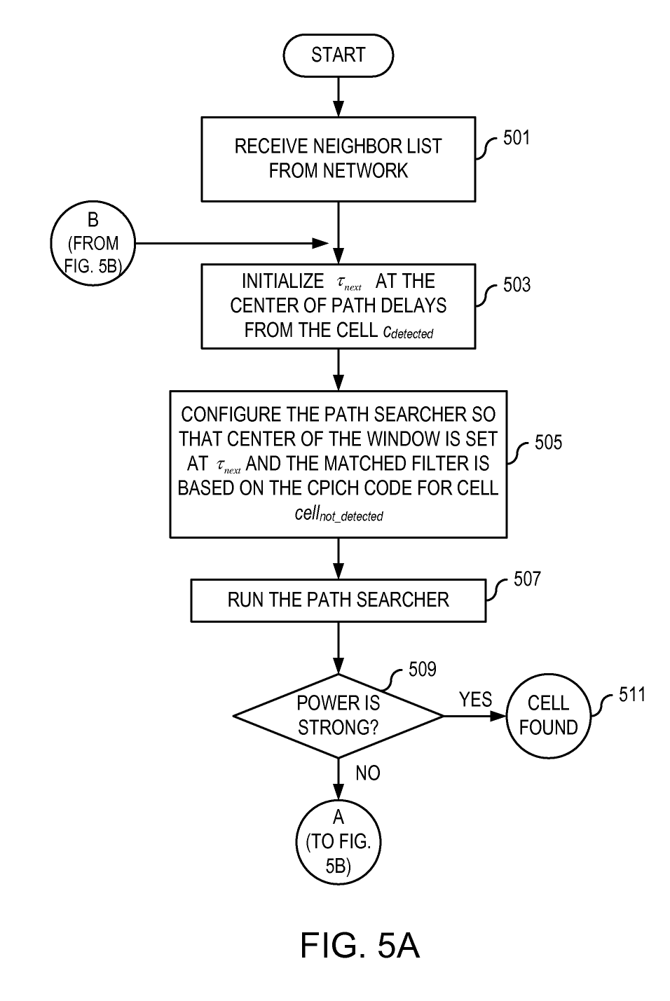

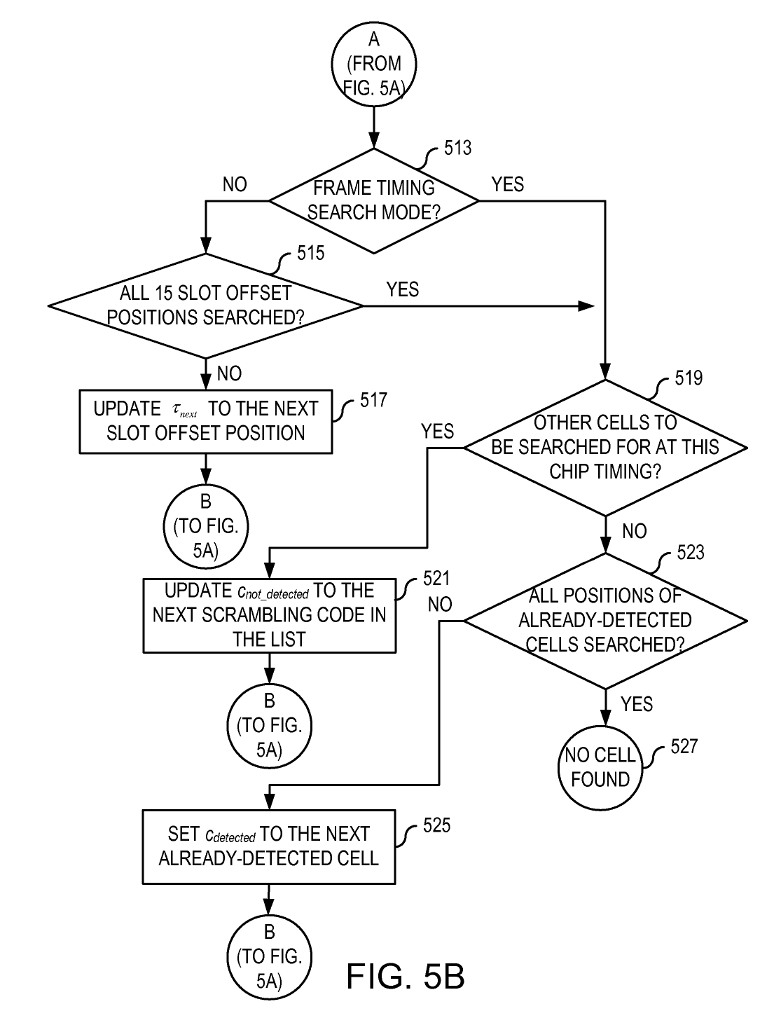

An exemplary embodiment of the processes/steps that are performed (e.g., in the path searcher 207) in accordance with the invention will now be described with reference to FIGS. 5A and 5B, which together constitute a flow chart. In this exemplary embodiment, there are two search modes in the time-overlapping cell search procedure: (1) Frame timing search mode, in which the overlapped search is performed at the same frame timing; and (2) Slot timing search mode, in which the overlapped search is performed at the same slot timing. Frame timing search mode covers Case (B) only, and ‘Slot timing search mode’ covers both Case (A) and (B). The mode of operation can be, for example, programmed into the UE (e.g., by setting a parameter stored in the UE's memory) so that it can be tested at the appropriate moment in the process. In alternative embodiments, the UE can be designed to operate exclusively in one mode or the other, making it unnecessary to set a parameter to indicate which of the two modes of operation is to be followed.

In an initialization aspect, the UE 200 receives a neighbor list (step 501) from a network that it is in communication with. The neighbor list provides the UE 200 with information that identifies nearby base stations, including what scrambling code each is using. To identify time-overlapping cells, the UE 200 only needs to focus on those cells in the neighbor list that have not yet been detected by the UE 200.

In another initialization aspect, the UE 200 initializes (step 503) a parameter, τₙₑₓₜ, to indicate the center of path delay positions from a cell, c_{detected}, where c_{detected} indicates a cell already detected by the UE 200, and τₙₑₓₜ={0, . . . ,38399}.

Next, the UE 200 configures (step 505) the path searcher 207 so that the center of the path searcher window is set at τₙₑₓₜ, and the matched filter is based on the Common Pilot Channel (CPICH) code for a cell, cₙₒₜ_{_{—}}_{detected}, selected from the set of not-yet-detected neighboring cells.

The path searcher 207 is then operated at the path delay position τₙₑₓₜ over a number of slots (e.g., 4 slots) (step 507). The measured signal power is then compared to a predetermined threshold (decision block 509). If the measured signal power is strong (“YES” path out of decision block 509), the procedure is terminated (procedure 511) to report the cell cₙₒₜ_{_{—}}_{detected} as a new cell to the higher layer, and to update a cell list to be searched.

If the measured signal power is not strong (“NO” path out of decision block 509), then further testing is performed. In particular, the mode of operation is tested (decision block 513) to determine whether it is Frame Timing Search Mode or Slot Timing Search Mode. If the present mode of operation is Slot Timing Search Mode (“NO” path out of decision block 513), more than one slot will be searched for the given cₙₒₜ_{_{—}}_{detected}, and processing proceeds to step 515 for this purpose. However, if the mode of operation is Frame Timing Search Mode (“YES” path out of decision block 513), then only one slot per cₙₒₜ_{_{—}}_{detected} is searched, and processing skips to step 519. It will be understood that in alternative embodiments in which the UE is designed to operate exclusively in only one of the two modes of operation, the test performed at decision block 513 is unnecessary, and the process is designed to always perform the corresponding set of steps.

Looking first at Slot Timing Search Mode, it is determined whether all (e.g., 15) of the slot offset positions within the frame have been searched for this particular cₙₒₜ_{_{—}}_{detected} (decision block 515). If yes (“YES” path out of decision block 515), processing proceeds to decision block 519.

If all of the slot offset positions within the frame have not yet been searched (“NO” path out of decision block 515), then the parameter τₙₑₓₜ is updated to indicate a next (as yet untested) slot offset position (step 517). In the exemplary embodiment, this means setting τₙₑₓₜ=(τₙₑₓₜ+2560) mod 38400. Processing then continues by jumping back to step 503, so that the testing can be repeated for this new slot offset position.

If the current mode of operation is Frame Timing Search Mode, or if all of the slot positions have been tested for a given cₙₒₜ_{_{—}}_{detected} in Slot Timing Search Mode, it is next determined whether there are other cells to be searched for at this chip timing (i.e., the chip timing corresponding to c_{detected}). If there are (“YES” path out of decision block 519), then the variable cₙₒₜ_{_{—}}_{detected} is updated to indicate a next not-yet-detected neighboring cell (step 521) (e.g., by indicating the scrambling code of the not-yet-detected neighboring cell), and processing continues by jumping back to step 503 so that the testing can be performed for this other cell.

If it is determined that there are no other cells to be searched for at this chip timing (“NO” path out of decision block 519), it is next determined whether the path delay position(s) of all already-detected cells have been searched (decision block 523). If not (“NO” path out of decision block 523), then the parameter c_{detected} is updated to indicate a next one of the already-detected cells (step 525), and processing continues by jumping back to step 503 so that the testing can be performed at the path delay timing of this next already-detected cell.

If testing has been performed at the path delay timings of all identified cells, then the process is completed by performing whatever procedure is called for when no overlapping cells are found (step 527). The particular procedure to be performed in this instance is application specific, and is therefore beyond the scope of this invention.

Embodiments in accordance with the various inventive aspects provide a number of advantages. One of these is that the new steps can be performed by processing technology that is already found in UE (e.g., the path searcher 207 as well as the cell searcher 211), so that embodiments need not require that extra processing hardware be added.

In addition, management of the path mask is simple because practicing the invention does not require that each path position be tracked to create a path mask. The window size of the path searcher 207 is usually wider than a path delay spread from one cell. As long as the path mask covers all path delays from a detected cell, the path searcher 207 can find undetected time-overlapping cells. In other words, a large amount of masking will not degrade total cell search performance, so long as the path searcher window is larger than the path-masked area.

The invention has been described with reference to particular embodiments. However, it will be readily apparent to those skilled in the art that it is possible to embody the invention in specific forms other than those of the embodiment described above.

For example, the above-described exemplary embodiment incorporated two possible modes of operation (i.e., Frame Timing Search Mode and Slot Timing Search Mode) into one procedure. However, alternative embodiments can be provided that are dedicated to only Frame Timing Search Mode, or in other alternative embodiments, dedicated to only Slot Timing Search Mode. Those of ordinary skill in the art will readily be able to adapt the described embodiments to practice such other alternative embodiments.

Thus, the described embodiments are merely illustrative and should not be considered restrictive in any way. The scope of the invention is given by the appended claims, rather than the preceding description, and all variations and equivalents which fall within the range of the claims are intended to be embraced therein.

What is claimed is:

1. A method of performing a cell search in a spread spectrum telecommunication system, comprising:
determining a spreading code of an undetected neighbor cell; and
de-spreading a received signal using the scrambling code of the undetected neighbor cell at a path delay position of an already-detected cell.

2. The method of claim 1, comprising:
receiving a neighbor list from a network of the spread spectrum telecommunication system; and
using the neighbor list to identify the undetected neighbor cell.

3. The method of claim 1, comprising:
concurrently performing a path-masked cell search procedure.

4. The method of claim 3, comprising:
using a cell searcher to perform the path-masked cell search procedure; and
using a path searcher to perform de-spreading the received signal using the scrambling code of the undetected neighbor cell at the path delay position of an already-detected cell.

5. The method of claim 1, wherein de-spreading the received signal using the scrambling code of the undetected neighbor cell at the path delay position of the already-detected cell comprises de-spreading the received signal using the scrambling code of the undetected neighbor cell at path delay positions of all already-detected cells.

6. The method of claim 1, wherein the path delay position of the already-detected cell is an offset from a known slot timing of the already-detected cell.

7. The method of claim 1, wherein the path delay position of the already-detected cell is an offset from a known frame timing of the already-detected cell.

8. The method of claim 1, wherein de-spreading the received signal using the scrambling code of the undetected neighbor cell at the path delay position of the already-detected cell comprises:
generating a plurality of correlation results by de-spreading the received signal using the scrambling code of the undetected neighbor cell at path delay positions of the already-detected cell at each of a plurality of slots; and
accumulating the correlation results.

9. An apparatus for performing a cell search in a spread spectrum telecommunication system, comprising:
logic configured to determine a spreading code of an undetected neighbor cell; and
logic configured to de-spread a received signal using the scrambling code of the undetected neighbor cell at a path delay position of an already-detected cell.

10. The apparatus of claim 9, comprising:
logic configured to receive a neighbor list from a network of the spread spectrum telecommunication system; and
logic configured to use the neighbor list to identify the undetected neighbor cell.

11. The apparatus of claim 9, comprising:
logic configured to concurrently perform a path-masked cell search procedure.

12. The apparatus of claim 11, comprising:
a cell searcher to perform the path-masked cell search procedure; and
a path searcher that comprises the logic configured to de-spread the received signal using the scrambling code of the undetected neighbor cell at the path delay position of an already-detected cell.

13. The apparatus of claim 9, wherein the logic configured to de-spread the received signal using the scrambling code of the undetected neighbor cell at the path delay position of the already-detected cell is part of logic configured to de-spread the received signal using the scrambling code of the undetected neighbor cell at path delay positions of all already-detected cells.

14. The apparatus of claim 9, wherein the path delay position of the already-detected cell is an offset from a known slot timing of the already-detected cell.

15. The apparatus of claim 9, wherein the path delay position of the already-detected cell is an offset from a known frame timing of the already-detected cell.

16. The apparatus of claim 9, wherein the logic configured to de-spread the received signal using the scrambling code of the undetected neighbor cell at the path delay position of the already-detected cell comprises:
logic configured to generate a plurality of correlation results by de-spreading the received signal using the scrambling code of the undetected neighbor cell at path delay positions of the already-detected cell at each of a plurality of slots; and
logic configured to accumulate the correlation results.
